(19) United States
(12) Patent Application Publication
(10) Pub. No.: US 2026/0281823 A1
(43) Pub. Date: Sep. 17, 2026

(54) Transmission of Application Session Start and Stop Indications in Dual Connectivity for QoE/RVQoE Measurements

(71) Applicant: Telefonaktiebolaget LM Ericsson (publ), Stockholm (SE)

(72) Inventors: Cecilia Eklöf, Täby (SE); Johan Rune, Lidingö (SE); Filip Barac, Huddinge (SE); Luca Lunardi, Genova (IT)

(21) Appl. No.: 19/472,363

(22) PCT Filed: Apr. 3, 2024
(86) PCT No.: PCT/SE2024/050299

§ 371 Date: Oct. 3, 2025

Related U.S. Application Data
(60) Provisional application No. 63/457,487, filed on Apr. 6, 2023.

(51) Int. Cl. H04W 28/24; H04W 24/08; H04W 24/10

(52) U.S. Cl. CPC H04W 28/24; H04W 24/08; H04W 24/10

(57) ABSTRACT

Methods and apparatuses for Quality of Experience (QoE) and/or Radio Access Network Visible QoE (RVQoE) measurement configuration A method performed by a UE comprises receiving, from a network node, a measurement configuration for a cell group pertaining to the network node. The method also comprises determining at least one network node to which session start and/or session stop indications should be transmitted. The method further comprises initiating transmission of at least one of a session start indication and a session stop indication to the determined at least one network node.

### TECHNICAL FIELD

The present disclosure relates to Quality of Experience (QoE), and in particular to methods and apparatuses for QoE and/or Radio Access Network Visible QoE (RVQoE), measurement configuration in RAN.

### BACKGROUND

Overview of the QoE framework

### Regular QoE

The Quality of Experience (QoE) measurements, also referred to as “application layer measurements”, have been specified for 3^{rd} Generation Partnership Project (3GPP) Long Term Evolution (LTE) and UMTS and are being specified for New Radio (NR) in 3GPP release 17. The purpose of the application layer measurements is to measure the end user experience when using certain applications. Currently QoE measurements for streaming services and for MTSI (Mobility Telephony Service for IMS) services are supported. For NR, at least Virtual Reality (VR) is likely to be added to the list of services for which QoE measurements are specified and supported.

The solutions in LTE and UMTS are similar with the overall principles as follows. Quality of Experience Measurement Collection (QMC) enables configuration of application layer measurements in the UE and transmission of QoE measurement result files (which may also be referred to as QoE reports) to the network by means of Radio Resource Control (RRC) signaling. An application layer measurement configuration (also called QoE measurement configuration or QoE configuration) that the Radio Access Network (RAN) receives from the Operation and Maintenance (OAM) system, or the Core Network (CN) is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP release 17 a new study item for “Study on NR QoE management and optimizations for diverse services”, TS 38.890 v17.0.0, for NR has been approved and concluded. The specification work for 3GPP release 17 is still ongoing. The purpose of the study item is to study solutions for QoE measurements in NR. QoE management in NR will not just collect the quality of experience parameters of streaming services but also consider the typical performance requirements of diverse services (e.g., AR/VR and Ultra-Reliable Low-Latency Communication, URLLC, of which at least VR seems to be covered in 3GPP release 17). Based on requirements of services, the NR study also included more adaptive QoE management schemes that enable network optimization to satisfy user experience for diverse services.

The configuration data related to QoE measurements (in standard specifications typically referred to as application layer measurements) consists of a service type indication, an indication of an area in which the measurements are to be performed (denoted area scope), an IP address of the entity the collected measurement results (that is, the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” which the network entities handling it, e.g., forwarding it to the UE, as well as the UE Access Stratum, typically cannot interpret and do not try to read. The specified service types in 3GPP release 16 are MTSI and streaming service (DASH), and in 3GPP release 17, at least service type VR will be added. An area scope is defined in terms of cells or network related areas. In UMTS, an area scope is defined as either a list of cells, a list of routing areas or a list of tracking areas. In LTE, an area scope is defined as either a list of cells or a list of tracking areas. In NR, an area scope will be defined as either a list of cells or a list of tracking areas.

QoE, and in particular QoE configuration, comes in two types: management-based (m-based) QoE configuration and signaling-based (s-based) QoE configuration. In both cases the QoE configuration originates in the OAM system or some other administrational entity, e.g., dealing with customer satisfaction. The entities are referred to herein as the OAM system (where the OAM system may also contain further entities). With management-based QoE (m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and fulfills any other relevant condition, such as supporting the concerned application/service type) and sends the m-based QoE configuration to these UEs.

With s-based QoE, the OAM system is interested in collecting QoE measurement results from a specific UE, for example, because a user of a UE has filed a complaint. The OAM system sends the s-based QoE configuration to the Home Subscriber Server (HSS) (in EPS/LTE) or Unified Data Manager (UDM) (in 5GS/NR), which forwards the QoE configuration to the UE's current core network node (CN), e.g., an Mobility Management Entity (MME) in EPS/LTE or an Access and Mobility Management Function (AMF) in 5G/NR. The CN then forwards the s-based QoE configuration to the RAN node that serves the concerned UE, and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality may be logically separated from the Trace functionality, but it may still partly reuse the Trace signaling mechanisms. In NR and LTE, a globally unique QoE reference (formed of MCC+MNC+QMC ID, where the QMC ID is a string of 24 bits) will be associated with each QoE configuration. The QoE reference is included in the container with measurement instructions and sent to the RAN (i.e., the gNB in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE. The measConfigAppLayerId is stored in the UE Access Stratum and forwarded in an AT Command (which is the type of instructions used in the communication between the UE's modem part and the UE's application layer) together with the service type indication and the container with the measurement instructions.

Reports with collected QoE measurement results (i.e., QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting may be configured to be periodic or only sent at the end of an application session. Furthermore, the RAN may instruct the UE to pause QoE reporting, for example, if the cell/gNB is in a state of overload.

The RAN is not aware of when an application session with an associated QoE measurement session is ongoing, and the UE Access Stratum is also not automatically aware of this. To alleviate this session start/stop indications can be introduced, which will be sent from the application layer in the UE to the UE AS and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, the release may be done when the UE has moved outside an area configured for the QoE measurements, commonly referred to as the area scope.

One capability supported by legacy solutions is to be able to keep the QoE measurement for the whole session, including during a handover situation. It may also be possible to let the UE continue with the QoE measurements on an ongoing application session until the application session ends, even if the UE in the meantime moves out of the configured area scope.

### RAN Visible QoE (RVQoE)

An extension of the QoE framework, which has been studied for 3GPP release 17 and which may subsequently be implemented in 3GPP is the concept of RAN visible QoE (RVQoE). The regular QoE reports are intended for the MCE, which is an entity outside the RAN, that is, a part of the OAM system, and the RAN cannot read the QoE reports (at least not according to specification, although gNB/eNB implementations are not prevented from doing so). In contrast, reported RVQoE metrics are intended for the RAN and are delivered to the RAN in a format that the RAN understands. The RVQOE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

### QoE Measurements in Legacy Systems

QoE measurements have been specified for LTE and UMTS, and they are being specified for NR. The purpose of the application layer measurements is to measure the end user experience when using certain applications. In existing systems QoE measurements for streaming services and for MTSI (Mobility Telephony Service for IMS) services are supported.

The solutions in LTE and UMTS are similar with the overall principles as follows. Quality of Experience Measurement Collection enables configuration of application layer measurements in the UE and transmission of QoE measurement result files by means of RRC signaling. Application layer measurement configuration received from O&M or CN is encapsulated in a transparent container, which is forwarded to UE in a downlink RRC message. Application layer measurements received from UE's higher layer are encapsulated in a transparent container and sent to network in an uplink RRC message. The result container is forwarded to a Trace Collector Entity (TCE).

In 3GPP release 17 a study item for “Study on NR QoE management and optimizations for diverse services” for NR has been carried out (as referred to above). The purpose of the study item was to study solutions for QoE measurements in NR. QoE management in NR will not just collect the experience parameters of streaming services but also consider the typical performance requirements of diverse services (such as AR/VR and URLLC).

The measurements may be initiated towards RAN in management-based manner, i.e. from an O&M node in a generic way e.g. for a group of UEs, which may be selected by the RAN, or they may also be initiated in a signaling-based manner, i.e. initiated from CN (on request from the O&M system) to RAN e.g. for a single specific UE. The configuration of the measurement includes the measurement details, which are encapsulated in a container that is transparent to RAN.

When initiated via the core network, the measurement is started towards a specific UE. For the LTE case, the “TRACE START” S1AP message is used, which carries, among others, the details about the measurement configuration the application should collect (in the “Container for application layer measurement configuration” Information Element, IE, transparent to the RAN) and the details to reach the trace collection entity to which the measurements should be sent.

Notifications of started and stopped application sessions with associated QoE measurement configurations are introduced, where these notifications are conveyed from the application layer in the UE and to the UE Access Stratum (that is, the radio layers in the UE) and then forwarded to the network. The notifications allow the network (at least the RAN) to be aware of when QoE measurements on an application session are ongoing. It is an implementation decision when the RAN stops the measurements. Typically, it is done when the UE has moved outside the configured area for measurement (also referred to as the area scope). However, this strategy is questioned by the desire to have QoE data that represent complete application sessions.

FIG. 1 shows a signaling diagram taken from 3GPP TS 28.405 v16.0.0; in this document the figure is referred to as “FIG. 4.2.1-1: QMC activation and reporting in LTE”. FIG. 1 provides a general overview (without showing all the details) of the signaling involved in QoE measurement configuration, from the O&M system to the UE.

One capability supported by legacy solutions is to also be able to keep the QoE measurement for the whole application session, even during handover situation, so that reported QoE measurement data cover complete application sessions.

### RRC Signaling

The QoE measurements are configured in the UE by means of RRC signaling. The configuration is done using the RRC message RRCReconfiguration containing the IE appLayerMeasConfig. The UE starts collecting QoE measurements when the session starts in the application layer and when a report is ready, it is sent to the network in the RRC message MeasurementReportAppLayer. The same RRC messages are used for both regular QoE and RAN visible QoE. A signaling diagram of the configuration and reporting of QoE measurements using RRC signaling is shown in FIG. 2.

### AT-Commands

AT commands are used for communication between the AS (radio) layer and the application layer in the UE. The AT commands are defined in 3GPP TS 27.007 v18.2.0. The AT commands are used in QoE for transferring the configuration from the RRC layer to the application and for transferring reports from the application layer to the RRC layer.

In 3GPP Rel-12, the LTE feature Dual Connectivity (DC) was introduced, to enable the UE to be connected in two cell groups, each controlled by an LTE access node, eNBs, labelled as the Master eNB, MeNB and the Secondary eNB, SeNB. The UE still only has one RRC connection with the network. In 3GPP, the Dual Connectivity (DC) solution has since then been evolved and is now also specified for NR as well as between LTE and NR. Multi-connectivity (MC) is the case when there are more than 2 nodes involved. With introduction of 5G, the term MR-DC (Multi-Radio Dual Connectivity, see also 3GPP TS 37.340 v17.4.0 was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the master node (MN), the UE may use one PCell and one or more SCell(s). And within the Secondary Cell Group, SCG, controlled by the secondary node (SN), the UE may use one Primary SCell (PSCell, also known as the primary SCG cell in NR) and one or more SCell(s). This combined case is illustrated in FIG. 1. In NR, the primary cell of a master or secondary cell group is sometimes also referred to as the Special Cell (SpCell). Hence, the SpCell in the MCG is the PCell and the SpCell in the SCG is the PSCell. A schematic diagram of dual connectivity combined with carrier aggregation in MR-DC is shown in FIG. 3.

There currently exist certain challenge(s). 3GPP is discussing QoE in NR-DC scenarios in rel-18. One agreement that was made in RAN3 is that: QoE reports can be transmitted to either MN or SN and the reporting leg (MCG or SCG) can be changed during the application session.

As a consequence of the above agreement, the QoE/RVQoE reports can be sent to either the MN or the SN and that the recipient node may change during the session. The background of the agreement is that the reports are preferably sent to the node which carries the session, that is, the node which has the radio bearer configured over which the data is transmitted. This is not known in advance and therefore the recipient node for the QoE/RVQOE reports may need to be changed after the session has started. However, the UE does not only send QoE/RVQoE reports during an application layer session, but also a session start indication when a session in the application layer starts, and a session stop indication when a session in the application layer stops. These indications are provided using the appLayerSessionStatus-r17 IE in the MeasurementReportAppLayer message (wherein the sessionStatus-r17 IE is an ENUMERATED which can be set to any of the values “started” and “stopped”). One use case for the session start and stop indications is to provide sufficient information to the network, so that the network knows when it can deconfigure QoE/RVQOE at area borders, or simply that the network is aware that no more QoE/RVQOE reports for this session are expected to arrive. The QoE/RVQoE measurements should not stop in the middle of the application layer session, so the network needs to wait with deconfiguring QoE at area borders, until the session is completed.

Another example is if the node wants to prioritize (for example, based on network policies) traffic pertaining to a certain application, application type or service type. Where it is desired to prioritize traffic in this way, it may be useful for the node to know when a session of such an application is started, ongoing and stopped, so that the node can take appropriate prioritizing actions.

When QoE/RVQOE measurements are configured in dual connectivity, they are configured by either the MN (Master Node) or the SN (Secondary Node). The node that made the configuration also “owns” the QoE/RVQoE configuration and it is assumed that it is the “owning” node that will monitor the area scope configured for the measurements and ensure that the UE performs the measurements in the right area. The ownership of the QoE/RVQOE measurements does not need to change due to change of the connectivity leg for the reporting, it may remain the same as before the reporting leg changed. The session start and stop indications are also used for alignment with Minimization of Drive Test (MDT) measurements, and in most cases the node owning the QoE configuration also handles the alignment with MDT.

The agreement related to the reporting leg for QoE does not consider the session start and stop indications. The session start and stop indications should not necessarily be sent to the node which receives the QoE/RVQOE reports. It is rather the node that “owns” the QoE/RVQoE configuration which needs to receive the session start and stop indications, even if the reports are sent to the other node, in order to handle the area of the measurements and alignment with MDT. It is desirable to provide means to ensure that the session start and stop indications are sent to the relevant node in dual connectivity.

3GPP TS 38.423 v17.4.0 discusses the NG-RAN Xn Application Protocol (XnAP).

### SUMMARY

It is an object of the present disclosure to provide improved direction of QoE indications in dual connectivity systems.

Certain aspects of the disclosure and their embodiments may provide solutions to these or other challenges.

Embodiments provide methods for UEs, methods for network nodes, UEs and network nodes.

Some embodiments provide UE methods, comprising:
Receiving, from a network node (a MN or a SN) a configuration of QoE/RVQoE measurements in a cell group, that is, either a Master Cell Group (MCG) related to an MN (Master Node) or a Secondary Cell Group (SCG) related to an SN (Secondary Node).
In some embodiments, receiving, from a network node (the MN or the SN), an instruction to transmit QoE/RVQoE reports to the other cell group. That means that if the UE received the QoE configuration from the MCG, it is instructed to send the QoE/RVQoE reports to the SCG, and if the UE received the QoE configuration from the SCG, it is instructed to send the QoE/RVQOE reports to the MCG. In some variants, the UE may be instructed to send the QoE reports to a node different than the one receiving the RVQOE reports (for example, QoE reports are sent to the MN and RVQoE reports are sent to the SN).
Being instructed regarding which node to transmit the session start and stop indications to.
   In some embodiments, the UE may be instructed to transmit the session start and stop indications to the node (MN or SN) which configured the UE with QoE/RVQoE measurements. Note that the MN or the SN may change during a connection, for example, due to mobility of the UE, but in this discussion is assumed that the node(s) that takes over the role of MN or the SN also inherits the “ownership” of the configuration from its predecessor, meaning that the UE, from now on, sends the indication to the new “owner” of the configuration (to the new MN, if the old MN was the owner, or to the new SN, if the old SN was the owner). The instruction may comprise an explicit indication transmitted to the UE, or it may comprise an instruction related to UE actions in the relevant scenario.
   In some embodiments, the UE may be instructed to transmit the session start and stop indications only to the node (MN or SN) which receives the QoE/RVQoE reports. The instruction may comprise an explicit indication transmitted to the UE, or it may comprise an instruction related to UE actions in the relevant scenario.
      If the UE is configured to send the QoE and RVQoE reports to different nodes, the node receiving the indication may forward it to the other node.
      If the UE is configured to send the QoE and RVQoE reports to different nodes, the instruction may comprises that the UE should send the session start/stop indications to the node receiving the RVQoE reports.
      If the UE is configured to send the QoE and RVQoE reports to different nodes, the instruction may comprise that the UE should send the session start/stop indications to the node receiving the QoE reports.
   In some embodiments, the UE may be instructed to transmit the session start and stop indications to both nodes (MN and SN). The instruction may comprise an explicit indication transmitted to the UE, or it may comprise an instruction related to UE actions in the relevant scenario.
Transmitting QoE/RVQoE reports to the indicated node(s) and transmitting session start and stop indications to the indicated node(s) (where the reports and indications may be sent to different nodes or groups of nodes).

Embodiments may provide that the session start and stop indications are sent to the relevant node when a UE is configured with QoE measurements and is operating in dual connectivity.

Certain embodiments may provide one or more of the following technical advantage(s). The node (Master Node or Secondary Node in dual connectivity) which needs to receive the session start and stop indications for QoE measurements, may receive it, even if the QoE reports are sent to the other node. This may ensure that the network can handle the area of the QoE measurements correctly, that is that the UE performs the QoE measurements in the defined area. It may also ensure that any alignment with MDT may be done correctly.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a signaling diagram taken from 3GPP TS 28.405 v16.0.0;

FIG. 2 is a signaling diagram of the configuration and reporting of QoE measurements using RRC signaling;

FIG. 3 is schematic diagram of dual connectivity combined with carrier aggregation in MR-DC;

FIG. 4 is a flow chart illustrating a method in accordance with some embodiments;

FIG. 5 is a flow chart illustrating a method in accordance with some embodiments;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

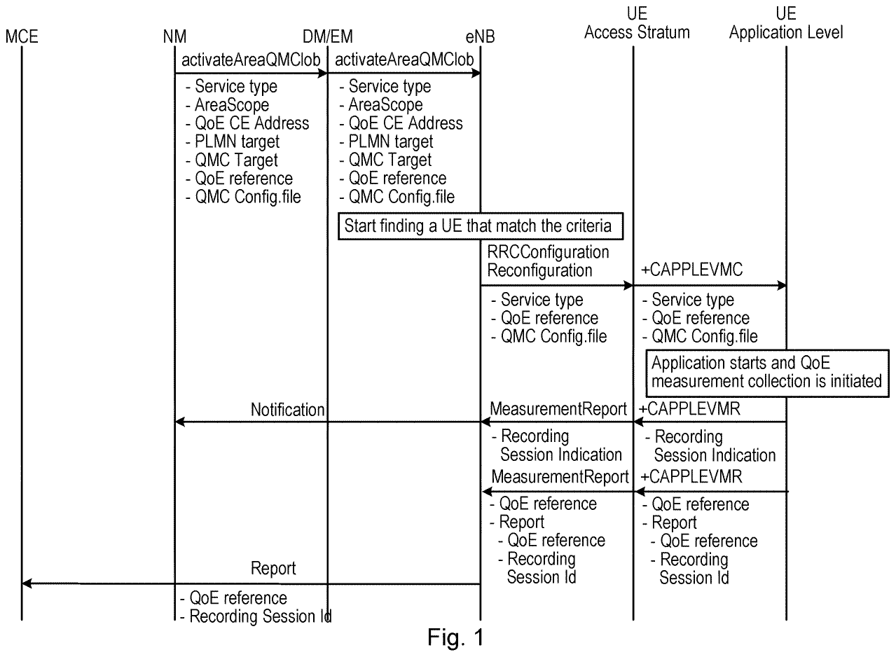

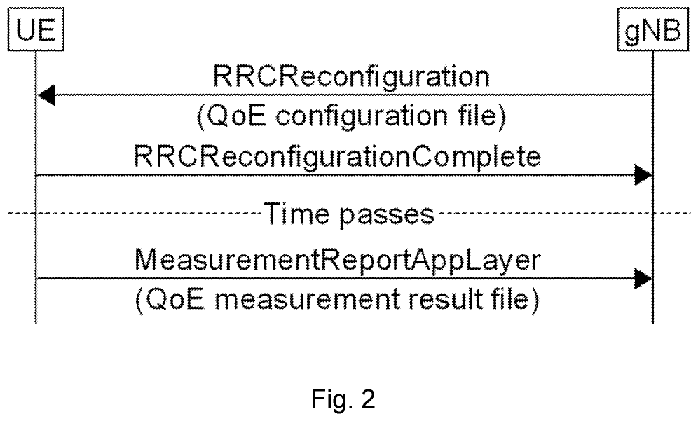

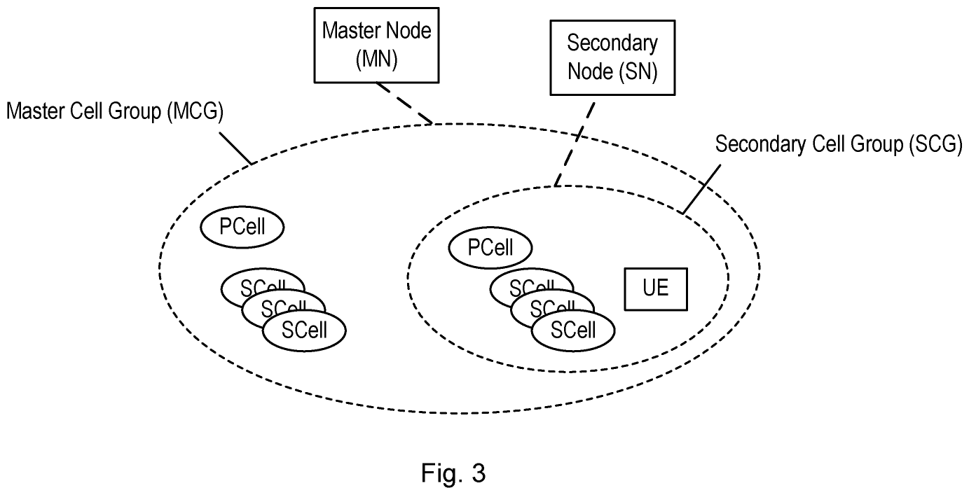

### DETAILED DESCRIPTION

Some of the embodiments contemplated herein will now be described more fully with reference to the accompanying drawings. Embodiments are provided by way of example to convey the scope of the subject matter to those skilled in the art.

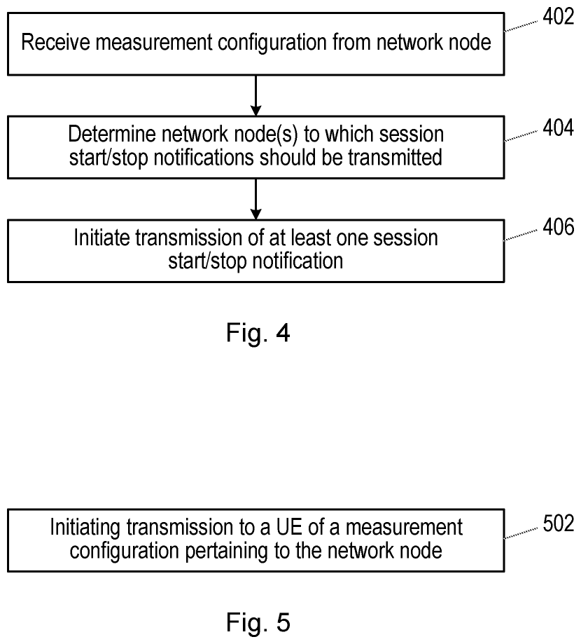

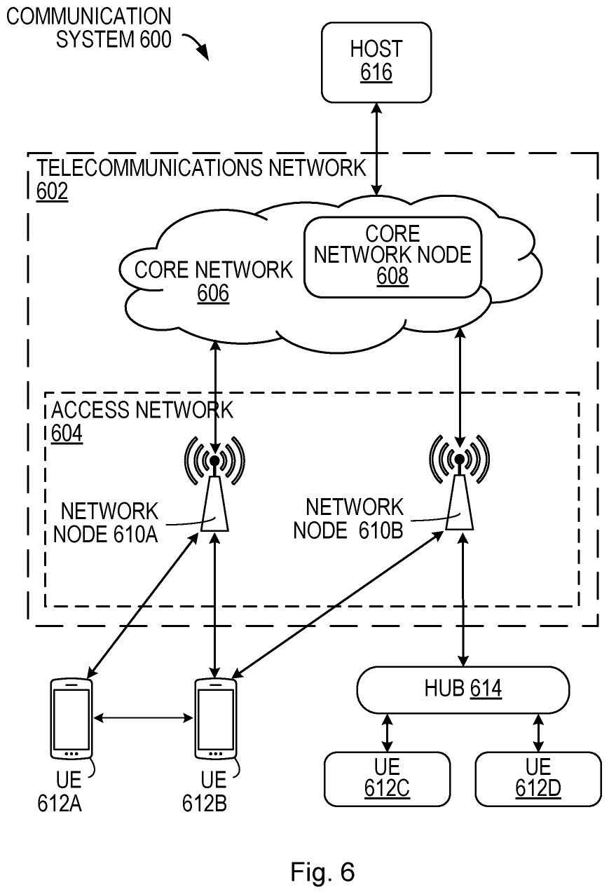

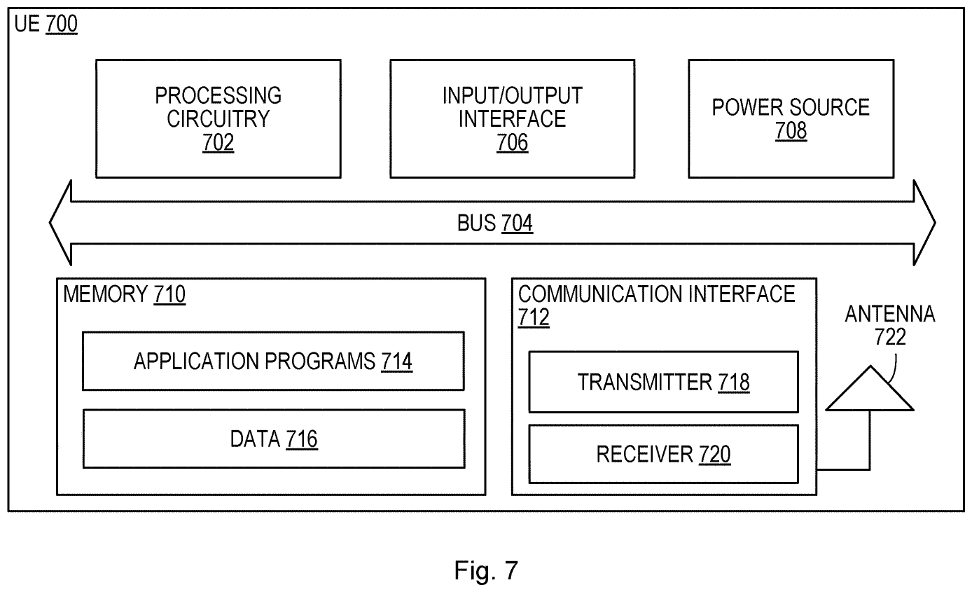

FIG. 4 depicts a method for QoE and/or RVQoE measurement configuration in accordance with particular embodiments. The method may be performed by a UE or wireless device (e.g. the UE 612 or UE 700 as described later with reference to FIGS. 6 and 7 respectively). The method begins at step 402 with the UE receiving, from a network node, a measurement configuration for a cell group pertaining to the network node. The method continues at step 404 with the UE determining at least one network node to which session start and/or session stop indications should be transmitted. The method further continues at step 406 with the UE initiating transmission of at least one of a session start notification and a session stop notification to the determined at least one network node.

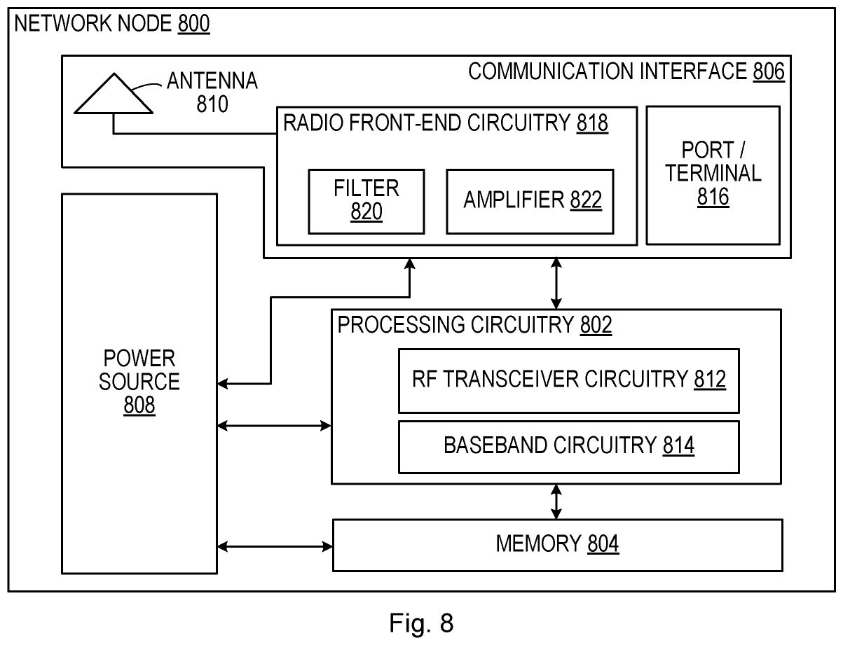

FIG. 5 depicts a method for QoE and/or RVQoE measurement configuration in accordance with particular embodiments. The method 5 may be performed by a network node (e.g. the network node 610 or network node 800 as described later with reference to FIGS. 6 and 8 respectively). The method begins at step 502 with the network node initiating transmission to a UE of a measurement configuration pertaining to the network node.

The terms “session start/stop indication” and “start/stop indication” are used interchangeably herein.

Embodiments are equally applicable to QoE and RVQoE measurements, unless explicitly stated otherwise.

Herein, the application layer in the UE is also referred to as the “UE application layer” or simply the “application layer”.

The terms “QoE configuration”, “QoE parameters”, “QoE information” and “QoE configuration information” are used interchangeably herein. The content therein is discussed herein, and may optionally include additional information related to the QoE measurements. The network, the UE AS and the UE application layer may store various parts thereof.

The entity performing the QoE measurements and other actions related to a QoE configuration, such as receiving QoE information from the UE AS, and/or sending QoE information to the UE AS, may be an application. The application typically resides on the application layer in the UE, and hence it is typically also correct to say that the application layer performs these actions. Herein, the performer of these various actions is sometimes said to be the application layer and sometimes said to be the application.

The terms “application layer measurement configuration”, “application measurement configuration”, “RVQoE measurement configuration”, “RVQoE configuration”, “RVQoE measurement and reporting configuration” and “QMC configuration” are used interchangeably.

While embodiments are discussed with reference to the interaction between the UE AS and UE application layer when handling/storing QoE information, they may also be applicable to RVQoE information.

All references to the application layer are with respect to the application layer of the UE.

The term “service” is often used as a short notation for “service type”, therefore “service” and “service types” may be seen as interchangeably unless explicitly stated otherwise.

Embodiments proposed herein apply to both signaling- and management-based QoE/RVQoE measurements (but may also optionally be restricted to apply to only one of them).

An instruction on whether the UE should send session start/stop indications) may provide an XML file containing a configuration of QoE measurements to be performed and reported (e.g. indicating QoE metrics to be collected and reported). This XML file is herein referred to with different terms, including at least “QMC configuration file” and “QoE configuration file”.

The functionality in a UE which 3GPP has named Access Stratum (where there is corresponding Access Stratum functionality in the network) is herein referred to in various ways, including “Access Stratum”, “AS”, “UE Access Stratum”, “UE AS”, “Access Stratum layer”, “AS layer”, “UE Access Stratum layer”, “UE AS layer”.

The terms “LTE” and “LTE node” imply that a network node that serves the UE is serving the UE by using the LTE radio access technology on the air interface (Uu).

The terms “NR” and “NR node” imply that a network node that serves the UE is serving the UE by using the NR radio access technology on the air interface (Uu).

Parameters/IEs/fields used in ASN.1 code as well as in procedural text in the 3GPP RRC specification for 5G/NR, i.e. 3GPP TS 38.331 version 17.3.0, are often named with a suffix indicating the number of the release of the 3GPP standard the parameter/IE/field was introduced in (e.g. the suffix “-r17” for a parameter/IE/field introduced in release 17 of the 3GPP standard). Parameters/IEs/fields following this naming convention are typically referred to both with and without the suffix, where the name including the suffix is used in the ASN.1 code (and thus defines the formal name from the ASN.1 compiler's perspective), while the name without the suffix is used in running text, e.g. in field descriptions and procedural text. Relevant examples in the context of the present disclosure include the parameters/IEs/fields AppLayerMeasConfig-r17/AppLayerMeasConfig and MeasConfigAppLayer-r17/MeasConfigAppLayer. In the present disclosure, both name variants may occur for various parameters/IEs/fields.

Strictly speaking, the session start/stop indications do not refer to the application session, but rather to the QoE measurement session associated with the application session. However, when the terms “session data” or “session data flow” are mentioned, they refer to the data or data flow of the application session with which the QoE measurement session is associated.

In the present disclosure, the term “flag” refers to an indication, that is, a parameter indicating something. An indication referred to as a flag is typically, but not necessarily, an indication that can indicate one of only two possible values, e.g. implemented as a single-bit indicator.

A node that has configured the UE with a QoE/RVQoE configuration is herein referred to as the “owner” of the QoE/RVQoE configuration. Note that the ownership may in some situations be transferred to another node, for example during mobility. For instance, if the MN is the owner of the QoE/RVQoE configuration, and the MN is changed due to a change of PCell (e.g. a handover), the ownership is transferred to the new MN. Similarly, as another example, if the SN is the owner of the QoE/RVQOE configuration, and the SN is changed (e.g. due to a SN/SCG change procedure), the ownership may be transferred to the new SN.

### DETAILED DESCRIPTION OF EMBODIMENTS RELATIVE TO THE HANDLING OF SESSION START AND STOP INDICATIONS IN DUAL CONNECTIVITY

Embodiments comprise methods to control the transmission of session start and stop indications for QoE/RVQOE measurements. A UE is configured with QoE/RVQOE measurements by either an MN (Master Node) or an SN (Secondary Node), when the UE is operating in dual connectivity. The UE may be instructed to transmit the QoE/RVQoE reports to a node different than the node that made the configuration, or different than the node that sent the configuration to the UE, or different than the node that the UE sends QoE reports and/or RVQoE reports to. Embodiments provide solutions to ensure that the relevant node(s) should receive the session start and stop indications in such scenarios.

In UE based embodiments, the UE may be instructed to transmit the session start and stop indications to a specific network node, an MN or an SN.

A method performed by a UE for QoE and/or RVQoE measurement configuration in accordance with embodiments may comprise one or more of the following steps.

Embodiments may comprise, by the UE, receiving, from a network node (a MN or a SN) a configuration of QoE/RVQOE measurements in a cell group, that is either a Master Cell Group (MCG) related to an MN (Master Node) or a Secondary Cell Group (SCG) related to an SN (Secondary Node).

Embodiments may comprise, by the UE, transmitting QoE/RVQoE reports to the other cell group. That means that if the UE received the QoE configuration from the MCG, it may be instructed to send the QoE/RVQOE reports to the SCG, and if the UE received the QoE configuration from the SCG, it may be instructed to send the QoE/RVQoE reports to the MCG. In some variants, the UE may be instructed to send the QoE reports to a node different than the one receiving the RVQoE reports (for example, QoE reports are sent to the MN and RVQoE reports are sent to the SN).

Embodiments may comprise, by the UE, determining at least one network node to which session start and/or session stop indications should be transmitted. The determination may comprise being instructed regarding which node to transmit the session start and stop indications to.

In some embodiments, the UE may be instructed to transmit the session start and stop indications to the node (MN or SN) which configured the UE with QoE/RVQoE measurements. Note that the MN or the SN may change during a connection, for example due to mobility of the UE, but in the present discussion it is assumed that the node(s) that takes over the role of MN or the SN also inherits the “ownership” of the configuration from its predecessor, meaning that the UE, from now on, sends the indication to the new “owner” of the configuration (to the new MN, if the old MN was the owner, or to the new SN, if the old SN was the owner). The instruction may comprise an explicit indication transmitted to the UE, or it may comprise an instruction related to UE actions in the relevant scenario.

In some embodiments, the UE may be instructed to transmit the session start and stop indications only to the node (MN or SN) which receives the QoE/RVQOE reports. The instruction may comprise an explicit indication transmitted to the UE, or it may comprise an instruction related to UE actions in the relevant scenario.
a. If the UE is configured to send the QoE and RVQoE reports to different nodes, the node receiving the indication may need to forward it to the other node.
b. If the UE is configured to send the QoE and RVQoE reports to different nodes, the instruction may comprise that the UE should send the session start/stop indications to the node receiving the RVQoE reports.
c. If the UE is configured to send the QoE and RVQoE reports to different nodes, the instruction may comprise that the UE should send the session start/stop indications to the node receiving the QoE reports.

In some embodiments, the UE may be instructed to transmit the session start and stop indications to both nodes (MN and SN). The instruction may comprise an explicit indication transmitted to the UE, or it may comprise an instruction related to UE actions in the relevant scenario.

In some embodiments, the UE may be instructed to transmit the session start indication and the session stop indication to the same node. In a variation, this may be conditional to the fact that the node in question carries the complete session (or at least part of the session, or at least the last portion of the session when session ends, or it carries the session at start and at least the last portion of the session when session ends).

In some embodiments, the UE may be instructed to transmit the session start indication to the node in the role of MN, and if the last portion of the session (until session ends) is delivered via the same node, and that node is acting as SN in the last portion of the session, the UE may indicate that the session stop indication needs to be forwarded to the node acting as MN.

In some embodiments, the UE may implicitly (for example, as a default instruction) or explicitly instructed to send the session start indication to the node that configured the QoE/RVQoE configuration in the UE, and may subsequently, while the session is ongoing, receive an instruction from the network to send the session stop indication to the other node.
a. A typical (but not the only possible) scenario for such embodiments is that the session is the first session associated with the concerned QoE/RVQoE configuration and while the session is ongoing, the node that configured the UE discovers that the concerned application session's data flow is carried on bearers handled by the other node (which e.g. may be discovered based on QFI(s) indicated in an RVQoE report).
b. In such embodiments, the instruction to send the session stop indication to the other node (that is, the node that did not configure the UE with the QoE/RVQoE configuration) may also comprise that both start and stop indications for any subsequent session pertaining to the same QoE/RVQoE configuration should be sent to the same node (that is, the node that did not configure the UE with the QoE/RVQoE configuration).
c. In such embodiments, the instruction to send the session stop indication (and optionally session start and stop indications for subsequent sessions) to the other node (that is, the node that did not configure the UE with the QoE/RVQoE configuration) may further comprise that the session stop indication (and optionally session start and stop indications for subsequent sessions) also should be sent to the node that configured the UE with the QoE/RVQoE configuration.
   i. Optionally, this may include that the UE, when sending the session stop indication (and optionally session start and stop indications for subsequent sessions) to the node that did not configure the UE with the QoE/RVQOE configuration, may indicate to the receiving node that it should forward the session stop (or session start) indication to its peer node, that is, to the node that configured the UE with the QoE/RVQoE configuration.

In some embodiments, the UE may be instructed to transmit the session start indication only to the node acting in a certain role (for example, the role of MN) when the session started. In a variation, the UE may be instructed so that, if the session at start is carried via the node with a role that has not the same role as the node that should receive the session start/stop indication, the UE adds a flag indicating which node is the final recipient of the session start indication (MN or SN). In another variation, the sending towards the node with a certain role (MN or SN) of the session start indication is based on condition(s). An example of condition can be the fact that both QoE report and RVQoE report are to be sent to the same node; for example to the MN. Another example of condition can be that QoE reports are to be sent to a first node and RVQoE report are to be sent towards a second node, regardless of the roles taken the first node and second node. A further example of condition can be that QoE reports are to be sent to the node with the role of MN (or alternatively to the node with the role of SN) and the RVQoE reports can to the be sent to any node. A further example of condition can be that RVQoE reports can be sent to the node with the role of MN (or to the node with the role of SN).

In some embodiments, the UE may be instructed to transmit one (or both) of the session start and/or session stop indications together with a flag indicating the role of the node (MN or SN), or which node (for example, the one which configured the UE with QoE/RVQoE) is the final destination of such indications.

In some embodiments, the instruction related to which node the UE should transmit the session start and/or session stop indications is implicit. In one example, the UE may send the above indications to the same node from which the QoE configuration (or the RVQoE configuration, or both) is received. In another example, the indication/command/reconfiguration sent to the UE to switch the sending of QoE and/or RVQoE reporting from one node (for example, the MN) to another node (for example, the SN) may implicitly indicate to the UE that the session stop indication is to be sent to the new node.

In some embodiments, the UE may be instructed to transmit the session stop indication only to the node acting in a certain role (for example, the role of MN) at session stop. In a variation, the UE may be instructed so that, if the session stops while it is carried via the node with a role that is not the same as the role of the node due to receive the session start/stop indication, the UE adds a flag indicating which node is the final receiver of the session stop indication (MN or SN). In another variation, the sending towards the node with a certain role (MN or SN) of the session stop indication is based on one or more condition(s). The same conditions as described for the session start indication, or different conditions, may apply.

In some embodiments, the UE may be instructed to transmit one of the session start indication or the session stop indication to assist the RAN in determining which node (MN or SN) is the one through which the session is going to be delivered (for the session start indication) or to inform which node (MN or SN) is the one through which the delivery of the session has terminated.
a. To this end, the UE may be instructed to send the session start indication of a future session to the node(s) that will carry the application session's data flow(s).
b. Alternatively, the UE may be instructed to send, together with the session start indication of a future session, an indication of which node(s) that will carry the application session's data flow(s). Optionally, this indication is included only if the other node (that is, the node that does not receive the session start indication) is the node that will carry the application session's data flow, or if both nodes will carry data pertaining to the application session.
c. As a further alternative, the UE may be instructed to indicate, together with the session start indication of a future session (that is, in the same MeasurementReportAppLayer message), the QFI(s) and/or DRB ID(s) associated with (or which will be associated with) the application session's data flow(s).

Embodiments may comprise, by the UE, transmitting QoE/RVQoE reports to the indicated node(s) and/or transmitting session start and stop indications to the indicated node(s).

In some embodiments, the same methods described for session start indication and session stop indication may apply to other application layer indications. One example can be a “session ongoing indication” which can be used to indicate whether a session has started and still ongoing, for example, upon a leg switch. Another example can be a “session start pending” (or equivalently, a “QoE/RVQoE configuration active” indication), to indicate that a UE has applied a QoE/RVQoE configuration, but no session has started yet, or previously started session is terminated.

In some embodiments, the destination to which the UE should send the session start/stop indications may be indicated using the SRB(s) the UE should use to send the MeasurementReportAppLayer message containing the session start/stop indication. To this end, the instruction could indicate e.g. one of:
a. SRB4
b. SRB5
c. SRB4 and SRB5
d. SRB1
e. SRB3
f. SRB1 and SRB3
g. SRB1 and SRB5
h. SRB3 and SRB4
i. Tunneled to the SN via SRB4 (e.g. using the ULInformationTransferMRDC message)
j. Tunneled to the MSN via SRB5 (e.g. using the ULInformationTransferMRDC message)
k. Tunneled to the SN via SRB1 (e.g. using the ULInformationTransferMRDC message)
l. Tunneled to the MN via SRB3 (e.g. using the ULInformationTransferMRDC message)
m. SRB4 and tunneled to the SN via SRB4 (e.g. using the ULInformationTransferMRDC message)
n. SRB1 and tunneled to the SN via SRB1 (e.g. using the ULInformationTransferMRDC message)
o. SRB5 and tunneled to the MN via SRB5 (e.g. using the ULInformationTransferMRDC message)
p. SRB3 and tunneled to the MN via SRB3 (e.g. using the ULInformationTransferMRDC message)

A method performed by a network node for QoE and/or RVQoE measurement configuration in accordance with embodiments may be as referred to in the context of the UE methods. The network node may be operating in dual connectivity, and may be a Master Node (MN) defining the configuration of an MCG (Master Cell Group) or a Secondary Node (SN) defining the configuration of an SCG (Secondary Cell Group).

In some embodiments, one of the MN/SN may carry the application session, or both nodes may carry the application session towards the UE.

In some embodiments, where split RAN architecture is used, in which the RVQoE reports are forwarded from the CU or CU-CP to the DU that serves the UE (that is, carries the data for the application session), the CU or CU-CP receiving the start/stop indication (directly from the UE or from another node that, in turn, received it from a UE) may also forward the session/start stop indication to the DU that carries the application session data. The CU/CU-CP may act either as the MN or the SN for the UE.
a. In one variant, the above is applicable for the case when the RVQoE reports are forwarded from the CU-CP to the CU-UP that serves the bearers that carry the application session data.

In some embodiments, if the gNB-CU-CP receiving the session start indication belongs (or, as an alternative does not belong) to the node that carries the application session data, it may use the reception of session start indication as trigger to send MDT configuration parameters to the served gNB-DU(s) and/or gNB-CU-UP(s) in case MDT alignment is needed/requested with QoE/RVQoE measurements.

In some embodiments, if the gNB-CU-CP receiving the session stop indication belongs (or, as an alternative does not belong) to the node that carries the session, it may use the reception of session stop indication as trigger to release the MDT configuration for the served gNB-DU(s) and/or gNB-CU-UP(s) in case MDT alignment is needed/requested with QoE/RVQoE measurements.

In some embodiments, if the gNB-CU-CP receiving the session start indication belongs to the MN (or as alternative, to the SN), it may use the reception of the session start indication as trigger to send MDT configuration parameters to the served gNB-DU(s) and/or gNB-CU-UP(s) in case MDT alignment is needed/requested with QoE/RVQoE measurements.

In some embodiments, if the gNB-CU-CP receiving the session stop indication belongs to the MN (or as alternative, to the SN), it may use the reception of the session stop indication as trigger to release MDT configuration for the served gNB-DU(s) and/or gNB-CU-UP(s) in case MDT alignment is needed/requested with QoE/RVQoE measurements.

### UE Capabilities

In order to perform methods in accordance with some embodiments, the UE should indicate to the network that it is capable of sending the start/stop indications according to embodiments, for example (non-limiting examples):
a. That it is capable of sending the indications to both nodes serving the UE in NR-DC.
b. That it is capable of sending the indications to only one of the two nodes node, e.g.,
c. The UE is capable of sending the session start and stop indications to the node that configured it with the QoE measurements.
d. The UE is capable of sending the session start and stop indications to the node that receives the QoE reports.
e. The UE is capable of sending a start indication only to the node that configured it with the measurements and is capable of sending the stop indication only to the node that receives the reports at the time of session stop.

### Example Technical Specification Impact

An example implementation of an embodiment in 3GPP TS 38.331 v 17.3.0 (as cited above), in which the instruction to the UE is described in field description is shown below:
AppLayerMeasConfig
   The IE AppLayerMeasConfig indicates configuration of application layer measurements.

| -- ASN1START | |
|---|---|
| -- TAG-APPLAYERMEASCONFIG-START | |
| AppLayerMeasConfig-r17 ::= | SEQUENCE { |
| measConfigAppLayerToAddModList-r17 | SEQUENCE (SIZE |
| (1..maxNrofAppLayerMeas-r17)) OF MeasConfigAppLayer-r17 | |
| OPTIONAL, -- Need N | |
| measConfigAppLayerToReleaseList-r17 | SEQUENCE (SIZE |
| (1..maxNrofAppLayerMeas-r17)) OF MeasConfigAppLayerId-r17 | |
| OPTIONAL, -- Need N | |
| rrc-SegAllowed-r17 | ENUMERATED {enabled} |
| OPTIONAL, -- Need R | |
| ... | |
| } | |
| MeasConfigAppLayer-r17 ::= | SEQUENCE { |
| measConfigAppLayerId-r17 | MeasConfigAppLayerId- |
| r17, | |
| measConfigAppLayerContainer-r17 | OCTET STRING (SIZE |
| (1..8000)) | |
| OPTIONAL, -- Need N | |
| serviceType-r17 | ENUMERATED |
| {streaming, mtsi, vr, spare5, spare4, spare3, spare2, spare1} | |
| OPTIONAL, -- Need M | |
| pauseReporting-r17 | BOOLEAN |
| OPTIONAL, -- Need M | |
| transmissionOfSessionStartStop-r17 | BOOLEAN |
| OPTIONAL, -- Need M | |
| ran-VisibleParameters-r17 | SetupRelease {RAN- |
| VisibleParameters-r17} | |
| OPTIONAL, -- Cond ServiceType | |
| ... | |
| } | |
| RAN-VisibleParameters-r17 ::= | SEQUENCE { |
| ran-VisiblePeriodicity-r17 | ENUMERATED {ms120, |
| ms240, ms480, ms640, ms1024} | |
| OPTIONAL, -- Need S | |
| numberOfBufferLevelEntries-r17 | INTEGER (1..8) |
| OPTIONAL, -- Need R | |
| reportPlayoutDelayForMediaStartup-r17 | BOOLEAN |

OPTIONAL, -- Need M
...
}
-- TAG-APPLAYERMEASCONFIG-STOP
-- ASN1STOP

AppLayerMeasConfig field descriptions

measConfigAppLayerContainer
The field contains configuration of application layer measurements, see Annex L
(normative) in TS 26.247 [68], clause 16.5 in TS 26.114 [69] and TS 26.118 [70].
pauseReporting
The field indicates whether the transmission of measReportAppLayerContainer is
paused or not. Value true indicates the transmission of measReportAppLayerContainer
is paused; value false indicates the transmission of measReportAppLayerContainer is
not paused.
ran-VisibleParameters
The field indicates whether RAN visible application layer measurements shall be
reported or not.
rrc-SegAllowed
This field indicates that RRC segmentation of MeasurementReportAppLayer is allowed.
It may be present only if the UE supports RRC segmentation of the
MeasurementReportAppLayer message in UL.
serviceType
Indicates the type of application layer measurement. Value streaming indicates Quality
of Experience Measurement Collection for streaming services (see TS 26.247 [68]),
value mtsi indicates Quality of Experience Measurement Collection for MTSI (see TS
26.114 [69]). value vr indicates Quality of Experience Measurement Collection for VR
service (see TS 26.118 [70]). The network always configures serviceType when
application layer measurements are initially configured and at fullConfig.
transmissionOfSessionStartStop
The field indicates whether the UE shall transmit indications when sessions in the
application layer start and stop. The UE transmits a session start indication upon
configuration of this field if a session already has started in the application layer. When
operating in dual connectivity, the UE transmits the session start and stop
indications to the cell group which configured the UE with application layer
measurements, even if the MeasurementReportAppLayer messages are
transmitted to the other cell group.

In some embodiments in which a network based solution is used, the proposed sending of start/stop indications between network nodes may be done by means of XnAP signalling, either as an explicit IE or as a container. For this purpose, existing XnAP messages may be enhanced or new XnAP messages may be defined. For the case of split RAN architecture described above, the indication may be sent via F1AP signalling from the CU/CU-CP that receives the indication from the UE or from another node, to the DU that serves the UE.

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 6, the hub 614 communicates with the access network 604 to facilitate indirect communication between one or more UEs (e.g., UE 612c and/or 612d) and network nodes (e.g., network node 610b). In some examples, the hub 614 may be a controller, router, a content source and analytics node, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs). The processing circuitry 702 may be operable to provide, either alone or in conjunction with other UE 700 components, such as the memory 710, UE 700 functionality. For example, the processing circuitry 702 may be configured to cause the UE 702 to perform the methods as described with reference to FIG. 4.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In some embodiments, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, a memory 804, a communication interface 806, and a power source 808, and/or any other component, or any combination thereof. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, network node 800 functionality. For example, the processing circuitry 802 may be configured to cause the network node to perform the methods as described with reference to FIG. 5.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

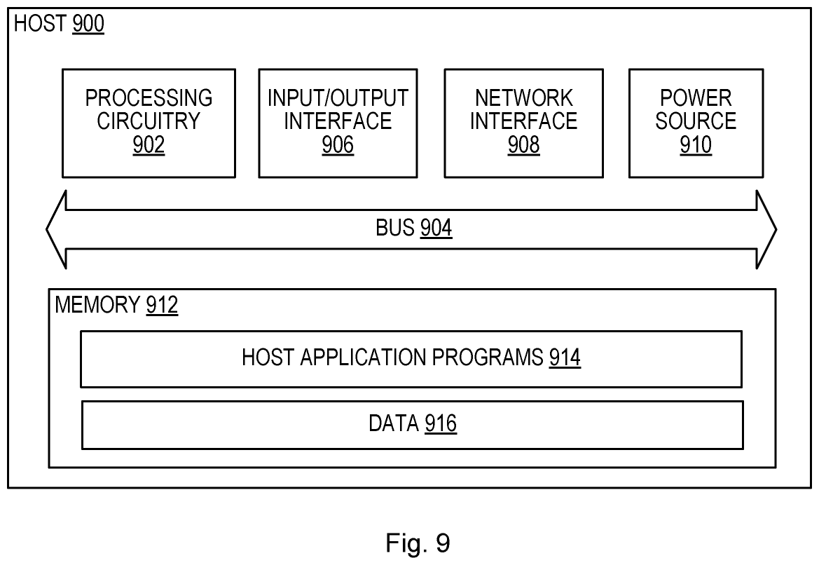

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

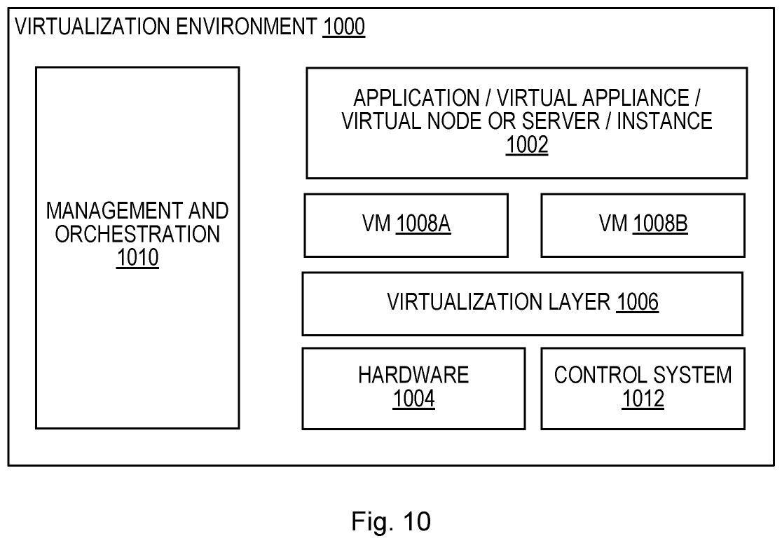

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

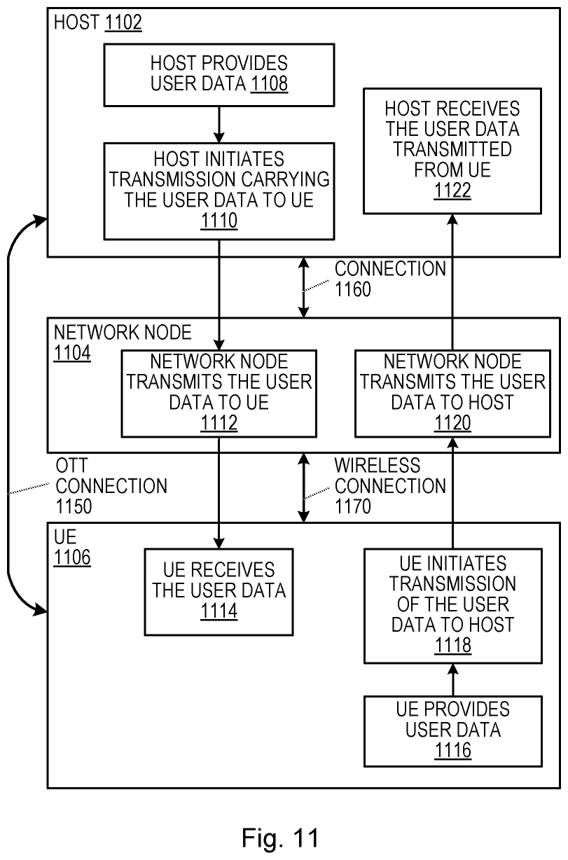

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the handling of QoE/RVQoE session start and session stop indications and thereby provide benefits such as improved QoE/RVQoE reporting and increased efficiency.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The following numbered statements provide additional information on the disclosure:
1. A method performed by a user equipment, UE, for Quality of Experience, QoE and/or Radio Access Network Visible QoE, RVQOE, measurement configuration, the method comprising:
   Receiving, from a network node, a measurement configuration for a cell group pertaining to the network node;
   Determining at least one network node to which session start and/or session stop indications should be transmitted; and
   Initiating transmission of at least one of a session start notification and a session stop notification to the determined at least one network node.
2. The method of statement 1, wherein the UE determines to transmit at least one of the session start indication and session stop indication to the network node from which the UE received the measurement configuration, or to a further network node, or to both the network node from which the UE received the measurement configuration and the further network node.
3. The method of statement 2, wherein the network node from which the UE received the measurement configuration is one of a master node, MN, of a master cell group MCG, and a secondary node, SN, of a secondary cell group, SCG, and the further network node is the other of the MN and the SN.
4. The method of statement 3 wherein, if the MN and/or SN changes between the time at which the session start indication is sent and the time at which the session stop indication is sent, the UE determines to transmit the session stop indication to the network node or nodes identified as the MN and/or SN at the time at which the session stop indication is to be sent.
5. The method of any preceding statement, wherein the UE determines the at least one network node to which session start and/or session stop indications should be transmitted:
   Based on an explicit session start/stop notification indication received by the UE; or
   Based on instructions for a given connection scenario stored at the UE.
6. The method of statement 5, wherein the UE determines the at least one network node to which session start and/or session stop indications should be transmitted based on the explicit session start/stop notification indication received by the UE, the explicit session start/stop notification indication being received by the UE after the UE has received the measurement configuration.
7. The method of any preceding statement, wherein the method further comprises:
   determining at least one network node to which measurement reports should be transmitted; and
   initiating transmission of a measurement report to the determined at least one network node.
8. The method of statement 7, wherein:
   the at least one network node to which measurement reports should be transmitted is/are the same as the at least one network node to which session start and/or session stop indications should be transmitted; or
   the at least one network node to which measurement reports should be transmitted is/are different to the at least one network node to which session start and/or session stop indications should be transmitted.
9. The method of any of statements 7 and 8, wherein the UE determines the at least one network node to which measurement reports should be transmitted:
   Based on an explicit measurement reports indication received by the UE; or
   Based on instructions for a given connection scenario stored at the UE.
10. The method of any preceding statement, wherein the measurement configuration comprises instructions for QoE measurements and/or wherein the measurement configuration comprises instructions for RVQoE measurements.
11. The method of statement 10, wherein the measurement configuration comprises instructions for QoE measurements and instructions for RVQoE measurements, and wherein the UE is instructed to send the QoE measurement reports to a different network node to the RVQoE measurement reports.
12. The method of statement 11, wherein the UE is instructed which network nodes to send the QoE measurement reports and the RVQoE measurement reports to by an explicit indication.
13. The method of any of statements 11 and 12, wherein the UE is further instructed which of: the one or more network nodes to which the QoE measurement reports are to be sent; and the one or more network nodes to which the RVQoE measurement reports are to be sent,
   is/are the network node/s to which session start and/or session stop indications should be transmitted.
14. The method of any preceding claim, wherein the UE initiates transmission of at least one of the session start notification and session stop notification including a flag.
15. The method of statement 14, wherein the flag indicates a specific network node that is the intended recipient of the notification in which the flag is included.
16. The method of statement 14, wherein the flag indicates whether a network node that is the intended recipient of the notification in which the flag is included is a MN or a SN.
17. The method of any preceding statement further comprising, by the UE, initiating transmission of a further notification.
18. The method of statement 17, wherein the at least one further notification comprises:
   A session ongoing notification; and
   A session start pending notification.
19. The method of any of the previous statements, further comprising:
   providing user data; and
   forwarding the user data to a host via the transmission to the network node.
20. A method performed by a network node for Quality of Experience, QoE and/or Radio Access Network Visible QoE, RVQOE, measurement configuration, the method comprising:
   Initiating transmission to a User Equipment, UE, of a measurement configuration pertaining to the network node;
21. The method of statement 20, further comprising receiving at least one of a session start notification and a session stop notification from the UE.
22. The method of statement 21, wherein the notification comprises a flag.
23. The method of statement 22, wherein the flag indicates that the network node is not the intended recipient of the notification, and the method further comprises initiating transmission of the notification to the intended recipient.
24. The method of any of statements 20 to 23 further comprising initiating transmission of an explicit start/stop notification indication to the UE.
25. The method of any of statements 20 to 24, further comprising receiving a measurement report from the UE
26. The method of any of statements 20 to 25, wherein the measurement configuration comprises instructions for QoE measurements and/or wherein the measurement configuration comprises instructions for RVQoE measurements.
27. The method of any of statements 20 to 26, further comprising receiving from the UE at least one of:
   A session ongoing notification; and
   A session start pending notification.
28. The method of any of statements 20 to 27, wherein the network node is a Master Node, MN, of a master cell group, MCG, or wherein the network node is a Secondary Node, SN, of a secondary cell group, SCG.
29. The method of any of statements 20 to 28, wherein the network node is a Central Unit, CU, in a split RAN architecture.
30. The method of statement 29, further comprising forwarding, by the CU, any received RVQoE reports and/or session start notifications and/or session stop notifications to a Distributed Unit, DU, serving the UE.
31. The method of any of statements 20 to 30, further comprising:
   obtaining user data; and
   forwarding the user data to a host or a UE.
32. A user equipment for Quality of Experience, QoE and/or Radio Access Network Visible QoE, RVQOE, measurement configuration, comprising:
   processing circuitry configured to cause the user equipment to perform any of the steps of any of statements 1 to 19; and
   power supply circuitry configured to supply power to the processing circuitry.
33. A network node for for Quality of Experience, QoE and/or Radio Access Network Visible QoE, RVQOE, measurement configuration, the network node comprising:
   processing circuitry configured to cause the network node to perform any of the steps of any of statements 20 to 31;
   power supply circuitry configured to supply power to the processing circuitry.
34. A user equipment (UE) for for Quality of Experience, QoE and/or Radio Access Network Visible QoE, RVQoE, measurement configuration, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of statements 1 to 19;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
35. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of statements 20 to 31 to transmit the user data from the host to the UE.
36. The host of statement 35, wherein:
   the processing circuitry of the host is configured to execute a host application that provides the user data; and
   the UE comprises processing circuitry configured to execute a client application associated with the host application to receive the transmission of user data from the host.
37. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of statements 20 to 31 to transmit the user data from the host to the UE.
38. The method of statement 37, further comprising, at the network node, transmitting the user data provided by the host for the UE.
39 The method of any of statements 37 and 38, wherein the user data is provided at the host by executing a host application that interacts with a client application executing on the UE, the client application being associated with the host application.
40. A communication system configured to provide an over-the-top (OTT) service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of statements 20 to 31 to transmit the user data from the host to the UE.
41. The communication system of statement 40, further comprising:
   the network node; and/or
   the UE.
42. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of statements 20 to 31 to receive the user data from a user equipment (UE) for the host.
43. The host of statement 42, wherein:
   the processing circuitry of the host is configured to execute a host application that receives the user data; and
   the host application is configured to interact with a client application executing on the UE, the client application being associated with the host application.
44. The host of the any of statements 42 and 43, wherein the initiating receipt of the user data comprises requesting the user data.
45. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of statements 20 to 31 to receive the user data from the UE for the host.
46. The method of statement 45, further comprising at the network node, transmitting the received user data to the host.
47. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the operations of any of statements 1 to 19 to receive the user data from the host.
48. The host of statement 47, wherein the cellular network further includes a network node configured to communicate with the UE to transmit the user data to the UE from the host.
49. The host of any of statements 47 and 48, wherein:
   the processing circuitry of the host is configured to execute a host application, thereby providing the user data; and
   the host application is configured to interact with a client application executing on the UE, the client application being associated with the host application.
50. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of statements 1 to 19 to receive the user data from the host.
51. The method of statement 50, further comprising:
at the host, executing a host application associated with a client application executing on the UE to receive the user data from the host application.
52. The method of statement 51, further comprising:
   at the host, transmitting input data to the client application executing on the UE, the input data being provided by executing the host application,
   wherein the user data is provided by the client application in response to the input data from the host application.
53. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform any of the steps of any of statements 1 to 19 to transmit the user data to the host.
54. The host of statement 53, wherein the cellular network further includes a network node configured to communicate with the UE to transmit the user data from the UE to the host.
55. The host of any of statements 53 and 54, wherein:
   the processing circuitry of the host is configured to execute a host application, thereby providing the user data; and
   the host application is configured to interact with a client application executing on the UE, the client application being associated with the host application.
56. A method implemented by a host configured to operate in a communication system that further includes a network node and a user equipment (UE), the method comprising:
   at the host, receiving user data transmitted to the host via the network node by the UE, wherein the UE performs any of the steps of any of statements 1 to 19 to transmit the user data to the host.
57. The method of statement 56, further comprising:
   at the host, executing a host application associated with a client application executing on the UE to receive the user data from the UE.
58. The method of any of statements 56 and 57, further comprising:
   at the host, transmitting input data to the client application executing on the UE, the input data being provided by executing the host application,
   wherein the user data is provided by the client application in response to the input data from the host application.

1.-34. (canceled)

35. A method performed by a user equipment (UE) for Quality of Experience (QoE) and/or Radio Access Network Visible QoE (RVQoE) measurement configuration, the method comprising:
receiving, from a network node, a measurement configuration for a cell group pertaining to the network node;
determining at least one network node to which session start and/or session stop indications should be transmitted; and
initiating transmission of at least one of a session start indication and a session stop indication to the determined at least one network node.

36. The method of claim 35, wherein the UE determines to transmit at least one of the session start indication and session stop indication to the network node from which the UE received the measurement configuration, or to a further network node, or to both the network node from which the UE received the measurement configuration and the further network node.

37. The method of claim 36, wherein the network node from which the UE received the measurement configuration is one of a master node (MN) of a master cell group (MCG) and a secondary node (SN) of a secondary cell group (SCG) and the further network node is the other of the MN and the SN.

38. The method of claim 37 wherein, if the MN and/or SN changes between the time at which the session start indication is sent and the time at which the session stop indication is sent, the UE determines to transmit the session stop indication to the network node or nodes identified as the MN and/or SN at the time at which the session stop indication is to be sent.

39. The method of claim 35, wherein the UE determines the at least one network node to which session start and/or session stop indications should be transmitted:
based on an explicit session start/stop indication received by the UE; or
based on instructions for a given connection scenario stored at the UE.

40. The method of claim 39, wherein the UE determines the at least one network node to which session start and/or session stop indications should be transmitted based on the explicit session start/stop indication received by the UE, the explicit session start/stop indication being received by the UE after the UE has received the measurement configuration.

41. The method of claim 35, wherein the method further comprises:
determining at least one network node to which measurement reports should be transmitted; and
initiating transmission of a measurement report to the determined at least one network node.

42. The method of claim 41, wherein:
the at least one network node to which measurement reports should be transmitted is/are the same as the at least one network node to which session start and/or session stop indications should be transmitted; or
the at least one network node to which measurement reports should be transmitted is/are different to the at least one network node to which session start and/or session stop indications should be transmitted.

43. The method of claim 41, wherein the UE determines the at least one network node to which measurement reports should be transmitted:
based on an explicit measurement reports indication received by the UE; or
based on instructions for a given connection scenario stored at the UE.

44. The method of claim 35, wherein the measurement configuration comprises instructions for QoE measurements and/or wherein the measurement configuration comprises instructions for RVQoE measurements.

45. The method of claim 44, wherein the measurement configuration comprises instructions for QoE measurements and instructions for RVQoE measurements, and wherein the UE is instructed to send the QoE measurement reports to a different network node to the RVQoE measurement reports.

46. The method of claim 45, wherein the UE is instructed which network nodes to send the QoE measurement reports and the RVQoE measurement reports to by an explicit indication.

47. The method of claim 45, wherein the UE is further instructed which of:
the one or more network nodes to which the QoE measurement reports are to be sent; and
the one or more network nodes to which the RVQoE measurement reports are to be sent, is/are the network node/s to which session start and/or session stop indications should be transmitted.

48. The method of claim 35, wherein the UE initiates transmission of at least one of the session start indication and session stop indication including a flag.

49. The method of claim 48, wherein the flag indicates a specific network node that is the intended recipient of the indication in which the flag is included, and/or wherein the flag indicates whether a network node that is the intended recipient of the indication in which the flag is included is a MN or a SN.

50. A method performed by a network node for Quality of Experience (QoE) and/or Radio Access Network Visible QoE (RVQoE) measurement configuration, the method comprising:
initiating transmission to a User Equipment (UE) of a measurement configuration pertaining to the network node,
wherein the measurement configuration comprises instructions for QoE measurements and/or wherein the measurement configuration comprises instructions for RVQoE measurements.

51. The method of claim 50, further comprising receiving at least one of a session start indication and a session stop indication from the UE.

52. The method of claim 51, wherein the indication comprises a flag.

53. The method of claim 52, wherein the flag indicates that the network node is not the intended recipient of the indication, and the method further comprises initiating transmission of the indication to the intended recipient.

54. The method of claim 50 further comprising initiating transmission of an explicit start/stop transmit indication to the UE.

55. The method of claim 50, further comprising receiving a measurement report from the UE.

56. A user equipment (UE) for Quality of Experience (QoE) and/or Radio Access Network Visible QoE (RVQoE) measurement configuration, comprising:
processing circuitry configured to cause the UE to: receive, from a network node, a measurement configuration for a cell group pertaining to the network node; determine at least one network node to which session start and/or session stop indications should be transmitted; and initiate transmission of at least one of a session start indication and a session stop indication to the determined at least one network node; and
power supply circuitry configured to supply power to the processing circuitry.

57. The UE of claim 56, wherein the processing circuitry is further configured to determine to transmit at least one of the session start indication and session stop indication to the network node from which the UE received the measurement configuration, or to a further network node, or to both the network node from which the UE received the measurement configuration and the further network node.

58. A network node for Quality of Experience (QoE) and/or Radio Access Network Visible QoE (RVQoE) measurement configuration, the network node comprising:
processing circuitry configured to cause the network node to initiate transmission to a User Equipment (UE) of a measurement configuration pertaining to the network node; and
power supply circuitry configured to supply power to the processing circuitry, wherein the measurement configuration comprises instructions for QoE measurements and/or wherein the measurement configuration comprises instructions for RVQoE measurements.

59. The network node of claim 58, wherein the processing circuitry is further configured to cause the network node to receive at least one of a session start indication and a session stop indication from the UE.
